(19) United States
(12) Patent Application Publication
(10) Pub. No.: US 2017/0095921 A1
(43) Pub. Date: Apr. 6, 2017

(54) Bit holder for a cordless power drill

(71) Applicants: Cary Madsen, Glenn Heights, TX (US); Manuel Alonzo, Glenn Heights, TX (US)

(72) Inventors: Cary Madsen, Glenn Heights, TX (US); Manuel Alonzo, Glenn Heights, TX (US)

(21) Appl. No.: 14/962,910

(22) Filed: Dec. 8, 2015

Related U.S. Application Data
(60) Provisional application No. 62/236,354, filed on Oct. 2, 2015.

(51) Int. Cl. B25H 3/00

(52) U.S. Cl. CPC B25H 3/003

(57) ABSTRACT

A bit holder for a cordless power drill provides a strap with a buckle and hook-and-loop fastener strips, which enable the user to easily secure the strap tightly around the battery pack of the power drill. An additional hook-and-loop fastener strip is provided on the strap, such that the user may affix a rectangular patch, which is provided, to the strap. The patch provides loops for the drill bits.

### CROSS-REFERENCE TO RELATED APPLICATIONS

This application claims the benefit of U.S. Provisional Application No. 62/236,354, filed Oct. 2, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to power tools and accessories, and in particular to a bit holder for a cordless power drill. For the carpenter and the handyman, the cordless power drill has proven to be extremely useful in many situations. Unfortunately, like the conventional power drill, its removable drill bits are easily dropped and lost.

A search of the prior art reveals various attachments which have been developed to secure the bits. None are closely related to the present invention, but several include features which resemble those of the present invention. Each has proven to be less than satisfactory in its own way. The present invention has been developed for the purpose of addressing and resolving these disadvantages. A bit holder for a cordless power drill, which provides a strap which may be easily secured to the battery pack of the power drill, would resolve these problems.

Drill tool strap assembly, U.S. Pat. No. 6,729,480 (filed Jan. 4, 2002), provides a bit holder intended for mounting on the body of the drill. One or more straps are intended to be wrapped around the handle of the drill, for the purpose of securing the strap assembly to the drill.

Drill bit holding system, U.S. Pat. No. 7,621,396 (filed Mar. 11, 2008), provides a bit holder intended for mounting on the body of the drill by wrapping around the body. The ends of the bit holder are affixed to each other by a coupling.

Apparatus including flash light and bit holder for attachment to an electric drill, U.S. Pat. No. 6,964,545 (filed Mar. 27, 2003), provides a bit holder intended for mounting on the top surface of the body of the drill by hook-and-loop fastener strips or some other releasable fastener.

Strap on drill paraphernalia holding system, U.S. Pat. No. 4,797,040 (filed Feb. 2, 1987), provides a bit holder intended for mounting on the body or handle of the drill. A strap is intended to be wrapped around the body handle of the drill, for the purpose of securing the holding system to the drill.

Self-adhesive bit holder, U.S. Pat. No. 5,188,242 (filed Nov. 1, 1991), provides a bit holder manufactured from rubber, intended for mounting on the drill, or some other surface such as a toolbox, with a peel-and-stick adhesive base.

Tool caddy, U.S. Pat. No. 4,508,221 (filed Sep. 21, 1981), provides a bit holder intended for mounting on the body of the drill, or some other tool, with a peel-and-stick adhesive base.

Worker's aid system and modified glove, U.S. Pat. No. 6,401,253 (filed Feb. 23, 2001), provides a bit holder capable of holding other items, such as a notepad, mounted on the back of a work glove. An alternate embodiment provides such a bit holder mounted on the bottom surface of the battery pack.

Tool caddy, U.S. Pat. No. 5,056,661 (filed Oct. 15, 1990), provides a bit holder with a strap, capable of being mounted on the body of the drill, the user's wrist, or the user's tool belt. The strap is secured with a buckle.

Accessory tray for a hand-held power tool, U.S. Pat. No. 6,364,580 (filed Feb. 10, 2000), provides a bit holder which is integral to the base of the drill, below the handle and immediately above the battery pack.

Most of these inventions secure the bit holder to the body or handle of the drill. Securing the bit holder to the handle of the drill creates a disadvantage by making the drill difficult to handle and operate. Securing the bit holder to the body of the drill creates a disadvantage by obstructing the user's view of the area to be drilled. The adhesive bit holders are too large to be adhered to the battery pack. If they are reconfigured to be smaller, the adhesive base would be difficult to adhere to the curved side surface of most battery packs. The worker's aid system (U.S. Pat. No. 6,401,253) is intended, in an alternate embodiment, to be mounted on the bottom surface of the battery pack, but this makes the drill bits difficult to reach and also introduces instability when the drill stands on the battery pack, causing it to tip over. The accessory tray (U.S. Pat. No. 6,364,580) also makes the drill bits difficult to reach. The present invention, which provides a strap to secure a bit holder to the battery pack of the drill while leaving the bit holder open and easily accessible, resolves the disadvantages of the prior art and is not anticipated by the prior art.

### SUMMARY OF THE INVENTION

Accordingly, the invention is directed to a bit holder for a cordless power drill. The bit holder provides a strap with a buckle and hook-and-loop fastener strips, which enable the user to easily secure the strap tightly around the battery pack of the power drill. An additional hook-and-loop fastener strip is provided on the strap, such that the user may affix a rectangular patch, which is provided, to the strap. The patch provides loops for the drill bits.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a side perspective view of the first exemplary embodiment secured to a battery pack, displaying the bit holder 10, the strap 11, the patch 13, the loops 15, and the battery pack 16.

FIG. 2 is a front perspective view of the first exemplary embodiment secured to a battery pack, displaying the strap 11, the buckle 12, the patch 13, and the battery pack 16.

FIG. 3 is a front view of the patch component of the first exemplary embodiment, displaying the patch 13, and the loops 15.

FIG. 4 is a rear perspective view of the patch component of the first exemplary embodiment, displaying the patch 13, a hook-and-loop fastener strip 14, and a loop 15.

FIG. 5 is a front view of the first exemplary embodiment with the patch component removed, displaying the strap 11, the buckle 12, and the hook-and-loop fastener strips 14.

FIG. 6 is a front view of the first exemplary embodiment, displaying the strap 11, the buckle 12, the patch 13, and the hook-and-loop fastener strips 14.

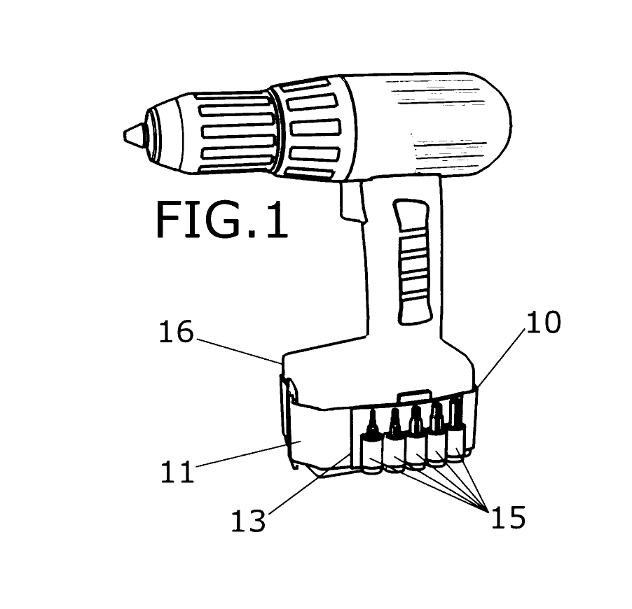

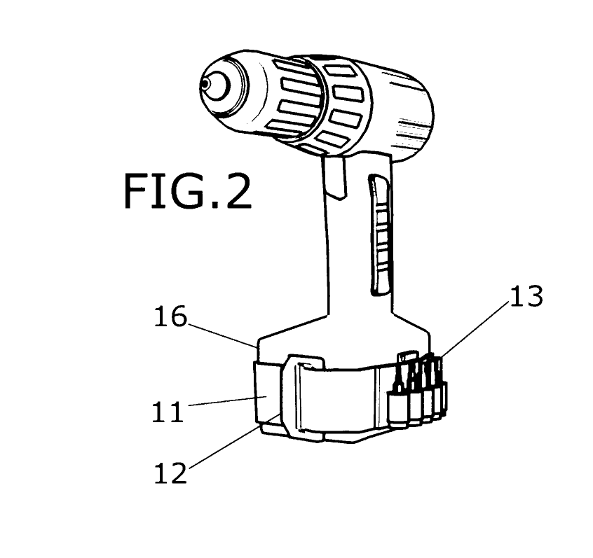

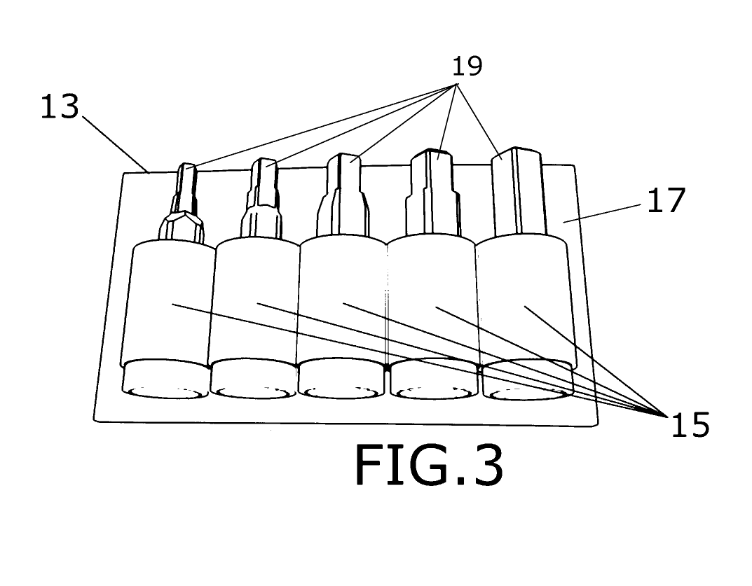

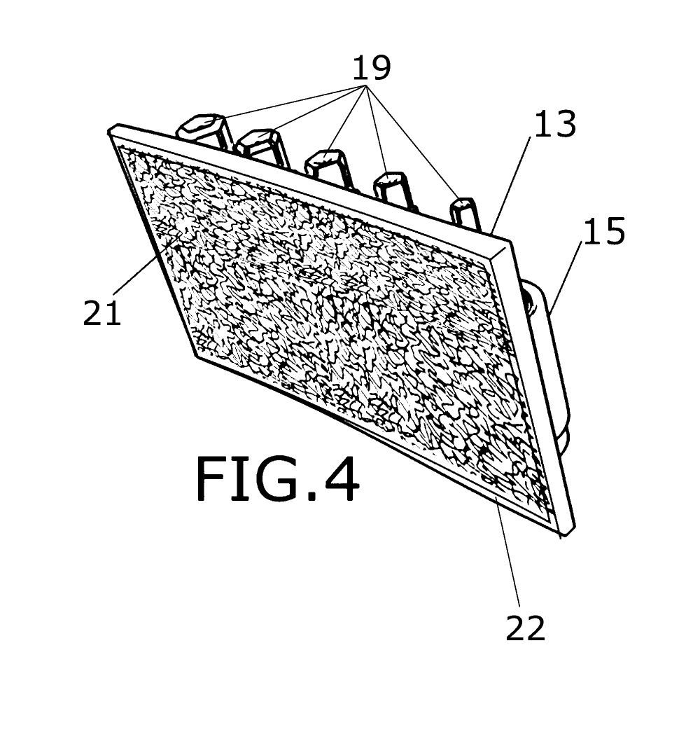

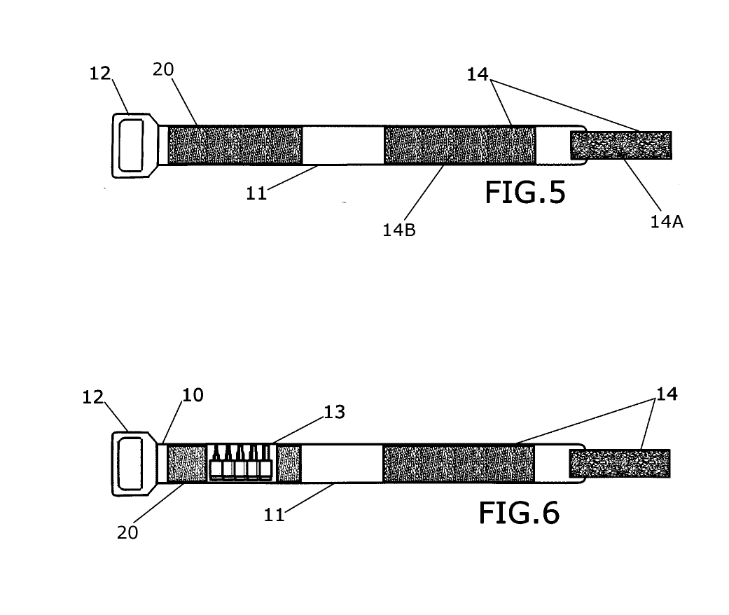

### DETAILED DESCRIPTION OF THE INVENTION

Referring now to the invention in more detail, the invention is directed to a bit holder 10 for a cordless power drill.

It is to be understood that while the invention is intended for use with the drill bits of a cordless power drill, this is not intended as a limitation. With suitable modifications or with no modifications at all, the invention may be used with any removable parts for any power tool or other equipment item.

The first exemplary embodiment is comprised of a bit holder 10 for a cordless power drill. The bit holder 10 provides a strap 11 with a buckle 12 and a hook-and-loop buckle fastener 14, which enable the user to easily secure the strap 11 tightly around the battery pack 16 of the power drill by feeding the loop fastener strip 14A through the buckle 12, folding it back upon itself, and pressing it against the hook fastener strip 14B. A patch hook-and-loop fastener strip 20 is provided on the strap 11, such that the user may affix a rectangular patch 13, which is provided, to the strap 11. The patch 13 provides loops 15 on its front surface for storage of the drill bits 19 and has a loop fastener strip 21 on its back surface 22 for securing the patch 13 to the strap 11 via the hook fastener strip 20. Optionally, the strap 11 may provide one or more additional hook fastener strips 20, such that one or more additional patches 13 may be affixed.

To use the first exemplary embodiment, the user may wrap the strap 11 around the battery pack 16 of the user's cordless power drill. The user then inserts the loop fastener strip 14A through the buckle 12, doubles back the end of the strap 11, pulls the end of the strap 11 such that the strap 11 is tightly secured to the battery pack 16, and presses the hook-and-loop fastener strips 14 together on the strap 11. The user then inserts the drill bits 19 into the loops 15 of the patch 13, and presses the patch 13 against a hook-and-loop fastener strip 20 such that it is secured to the strap 11.

The strap 11, the patch 13, and the hook-and-loop fastener strips 14 are preferably manufactured from a flexible, durable material which is substantially waterproof, such as nylon. The buckle 11 is preferably manufactured from a rigid, durable material which is corrosion resistant, such as stainless steel, plastic, brass, or aluminum alloy.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A bit holder for a power drill, comprising:
a. a strap having a buckle and a hook-and-loop buckle fastener;
b. said strap having at least one hook-and-loop patch fastener strip;
c. at least one rectangular patch;
d. said at least one rectangular patch having a hook-and-loop fastener strip on a back surface and being configured such that said rectangular patch may be affixed to said hook-and-loop patch fastener strip on the strap; and
e. said rectangular patch, providing a plurality of loops on a front surface for the storage of drill bits or other removable parts for tools.

2. The bit holder of claim 1, wherein the strap, the hook-and-loop buckle fastener, the hook-and-loop patch fastener strip, and the rectangular patch are manufactured from a semi-rigid, durable material such as nylon.

3. The bit holder of claim 1, wherein the buckle is manufactured from a rigid, durable material such as plastic, steel, or aluminum.

4. The bit holder of claim 1, wherein the strap, the hook-and-loop buckle fastener, the hook-and-loop patch fastener strip, and the rectangular patch are manufactured from a material which is easily cleaned.

5. The bit holder of claim 1, wherein the strap is secured tightly around the battery pack of a cordless power drill or other tool by passing the hook-and-loop buckle fastener through the buckle, doubling the end of the hook-and loop buckle fastener back upon itself, and then pressing the two hook-and-loop buckle fastener strips together.

6. The bit holder of claim 5, wherein the strap, the hook-and-loop buckle fastener, the hook-and-loop patch fastener strip, and the rectangular patch are manufactured from a semi-rigid, durable material such as nylon.

7. The bit holder of claim 5, wherein the buckle is manufactured from a rigid, durable material such as plastic, steel, or aluminum.

8. The bit holder of claim 5, wherein the strap, the hook-and-loop buckle fastener, the hook-and-loop patch fastener strip, and the rectangular patch are manufactured from a material which is easily cleaned.

9. The bit holder of claim 5, wherein one or more additional hook-and-loop patch fastener strips are provided on the strap, such that additional rectangular patches may be affixed to the additional hook-and-loop patch fastener strips.

10. The bit holder of claim 9, wherein the strap, the hook-and-loop buckle fastener, the hook-and-loop patch fastener strip, and the rectangular patch are manufactured from a semi-rigid, durable material such as nylon.

11. The bit holder of claim 9, wherein the buckle is manufactured from a rigid, durable material such as plastic, steel, or aluminum.

12. The bit holder of claim 9, wherein the strap, the hook-and-loop buckle fastener, the hook-and-loop patch fastener strip, and the rectangular patch are manufactured from a material which is easily cleaned.

13. The bit holder of claim 1, wherein one or more additional hook-and-loop patch fastener strips are provided on the strap, such that additional rectangular patches may be affixed to the additional hook-and-loop patch fastener strips.

14. The bit holder of claim 13, wherein the strap, the hook-and-loop buckle fastener, the hook-and-loop patch fastener strip, and the rectangular patch are manufactured from a semi-rigid, durable material such as nylon.

15. The bit holder of claim 13, wherein the buckle is manufactured from a rigid, durable material such as plastic, steel, or aluminum.

16. The bit holder of claim 13, wherein the strap, the hook-and-loop buckle fastener, the hook-and-loop patch fastener strip, and the rectangular patch are manufactured from a material which is easily cleaned.
